(19) United States
(12) Patent Application Publication
(10) Pub. No.: US 2008/0116017 A1
(43) Pub. Date: May 22, 2008

(54) Elevator car overload warning system and method

(76) Inventor: James R. Kress, Waterford, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/602,420

(22) Filed: Nov. 20, 2006

(51) Int. Cl. B66B 1/34

(52) U.S. Cl. 187/392

(57) ABSTRACT

An elevator car overload warning system which includes a weight sensor for sensing the weight of a load in the elevator car, a control unit connected to the sensor for detecting signals emitted from the sensor and thereby computing the weight of the load in the car and an annunciator connected to the control unit and positioned within the car for annunciation to passengers within the car that the load limit of car has been exceeded.

### BACKGROUND OF THE INVENTION

The present invention relates generally to an apparatus and method for providing a warning system when an elevator car is in an overloaded condition.

Electric an hydraulic elevators have been used extensively for many years for the purpose of transferring people and/or goods from one floor of a building to another. Many different types of load weighing systems have been developed over the years for the purpose of detecting overload conditions and to thereby modifying operating conditions of the elevator car. However, in spite of the use of such overload monitors on elevator cars, tragedy is not eliminated in overload conditions. In fact, in more recent times, an overloaded elevator at a football stadium resulted in the death of a student. The sad realization is that the use of any of the present day overload detecting systems used for elevator cars would not have prevented this accident.

It is therefore an object of the present invention to provide an elevator car overload warning system and method which eliminates the future possibility of the occurrence of such accidents.

### SUMMARY OF THE INVENTION

The elevator car overload warning system of the present invention includes a weight sensor for sensing the weight of a load in the car and further includes a control unit connected to the sensor for detecting signals emitted from the sensor and thereby computes the weight of a load in the car. An annunciator is connected to this control unit and positioned within the car for thereby directly annunciating to the passengers within the car that the load limit of the car has been exceeded. The annunciator can include a prerecorded voice message and in any event informs the passengers in principal that the car will not operate until the overload condition is corrected and that passengers need to immediately exit the elevator.

Such a system would have eliminated the sad accident previously discussed. The elevator would not have operated and an announcement would have been immediately given to the passengers that some of the passengers would have to immediately exit the car before the elevator would operate. The overload sensing monitors of the prior art do not so directly annunciate to the passengers and they therefore could not prevent such an unfortunate accident.

The weight sensor may take on any conventional form, such as strain gauges, pressures transducers positioned external to the elevator car or an array of weight sensors positioned on a floor of the elevator car. In the latter situation, the control unit of the warning system of the present invention can further compute weight for a given area for thereby calculating whether or not a passenger is lying on the floor of the elevator. For example, should a passenger collapse because of a medical condition and by lying on the car floor, the warning system can detect the condition and annunciate the condition to personnel at a remote location.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the present invention wherein:

FIG. 1 is a schematic view in side elevation of an elevator car with the overload warning system of the present invention; and

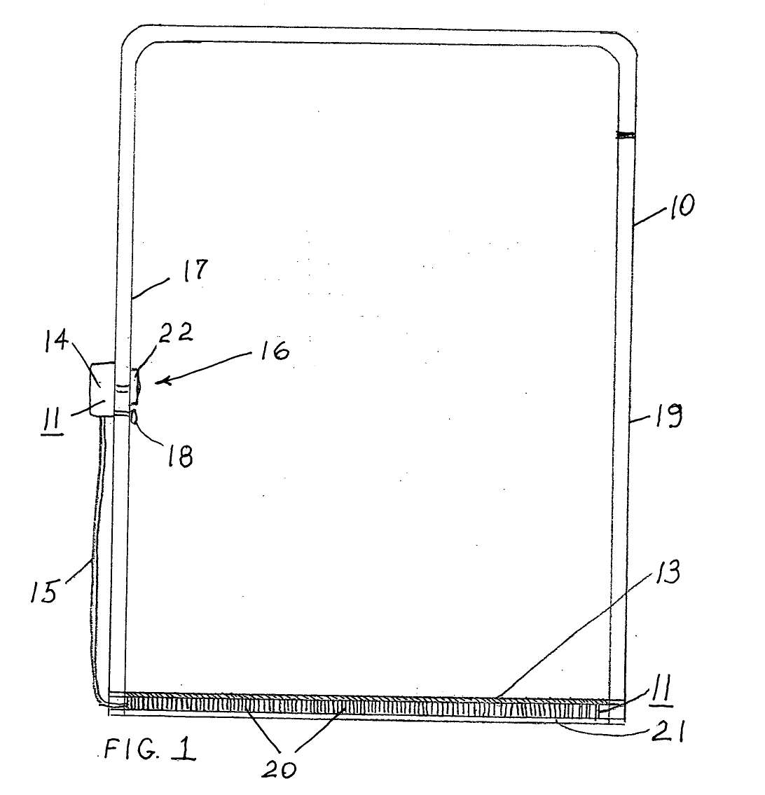

FIG. 2 is a schematic plan view of the floor area of the elevator car shown in FIG. 1 with a portion of the floor covering cut away to show the weight sensor.

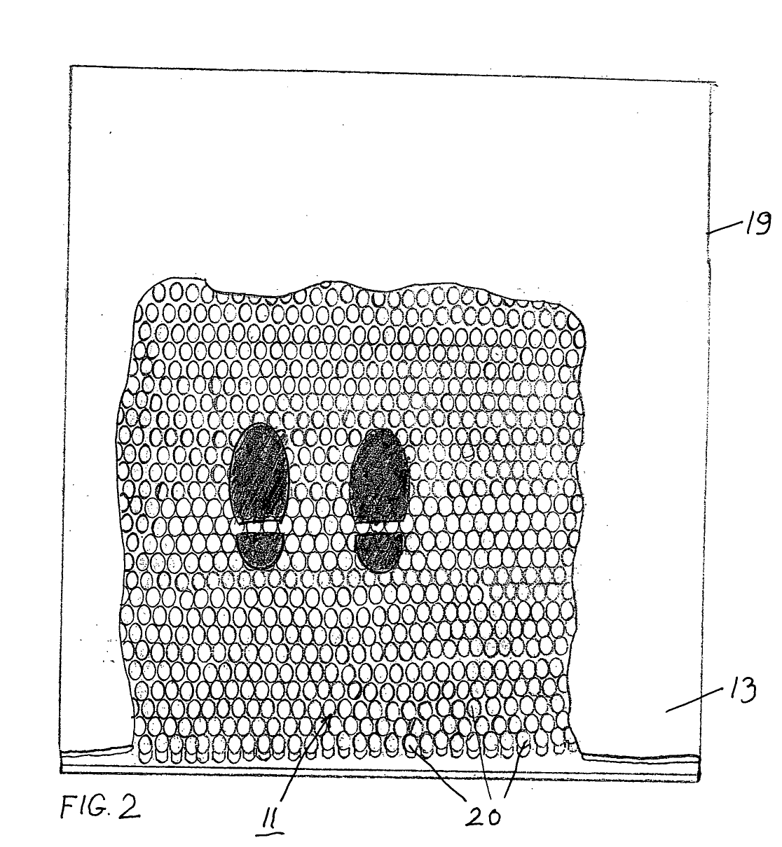

### DETAILED DESCRIPTION OF A PREFERRED EMBODIMENT

Referring to the drawings, the elevator car 10 is provided with the overload warning system 11 of the present invention. The overload warning system 11 is comprised of a weight sensor 12 for sensing the weight of a load (not shown) such as passengers on the floor covering surface 13 of the car 10. A control unit 14 is connected to sensor 12 via wire harness 15 for detecting signals emitted from the sensor 12 and thereby computing the weight of a load in the car 10. An annunciator 16 is connected to the control unit 11 and positioned within car 10 as illustrated here on back wall 17 for annunciation to passengers within the car 10 if the load limit of the car has been exceeded. The annunciator 16 preferably includes a prerecorded voice message as played over the audible speaker 18. The voice message informs the passengers in principal that the car will not operate until the overload condition is corrected by exiting passengers. Thus the car doors 19 remain open and the elevator will not operate until the required number of passengers exit the car 10 thereby alleviating the overload condition. This provides immediate notification to the passengers to immediate correct the situation so that the overload condition is not exacerbated and it is corrected quickly.

For example, the voice message might read “Danger. This elevator is overloaded and passengers must exit immediately.”

The sensor 12 shown in the drawings is comprised of an array of weight sensors or weight sensor cells 20, such as pressure sensors, positioned on the floor 21 of the elevator car 10 and covered with a flexible thin durable floor covering surface 13, which will transmit the weight of the passengers therethrough to the underlying cells 20. The control unit 14 reads the cumulative signals emitted from the respective weight sensor cells 20 via wire harness 15.

Control unit 14 is basically a small computer and is also programmed for computing weight per area by using sensor 21 over a given floor area of the car 10 for thereby calculating that a passenger is lying on the car floor 13. Thus, this arrangement is such that the control unit 14 can calculate when a passenger has collapsed because of a medical condition or for other reasons, and thereby send a signal in this situation to a remote location (not shown) for remote annunciation of either an overload condition or to indicate that a passenger is lying on the floor to remotely located personnel.

In order to determine when a passenger is lying on the floor, the unit 11 calculates the total weight of the passengers over a total foot surface area within the car 10. From this, the unit 14 can detect that the weight distribution is such that a passenger is lying on the car floor.

The sensor 21 comprised of the array of cells 20 thus makes up a matrix style mat that is fitted to the floor area 20 inside the elevator car and then covered with flexible durable floor covering 13. This type of matrix sensor array 21 is preferred when it is desired to detect when a passenger is lying on the floor. Otherwise, other types of sensors may be used instead, such as strain gauges or pressure transducers, such as piezoelectric crystals mounted exteriorly of the car 10. See for example the weight sensors indicated in U.S. Pat. No. 5,004,076. Also, in the instance of a hydraulically operated elevator, hydraulic pressure monitors can be used for the weight sensor as explained in U.S. Pat. No. 4,438,831. Each cell 20 of the array shown for sensor 21 may consist of a piezoelectric sensor of the type explained, for example, in U.S. Pat. No. 6,615,175. Other load cells which may be incorporated into the structure of the present invention are shown in U.S. Pat. Nos. 6,357,554 and 6,483,047.

In addition to the audible voice message communicated to passengers in the elevator car 10 by means of speaker 18, a light flashing placard 22 providing lighted emergency signage may also be provided. Such voice messages and singage may also be provided on each floor adjacent the elevator car entrance.

I claim:

1. An elevator car overload warning system, comprising:
a weight sensor for sensing the weight of a load in said car;
a control unit connected to said sensor for detecting signals emitted from said sensor and thereby computing the weight of a load in said car; and
an annunciator connected to said control unit and positioned within said car for annunciation to passengers within said car that the load limit of said car has been exceeded.

2. The elevator car overload warning system of claim 1, wherein said annunciator includes a prerecorded voice message.

3. The elevator car overload warning system of claim 2, wherein said voice message informs the passengers in principal that the car will not operate until the overload condition is corrected by immediate exiting of passengers.

4. The elevator car overload warning system of claim 1, wherein said annunciator includes lighted signage.

5. The elevator car overload warning system of claim 1, wherein said sensor includes an array of weight sensors positioned on a floor of said car.

6. The elevator car overload warning system of claim 5, said control unit including means for also computing weight per area for thereby calculating that a passenger is lying on the car floor.

7. The elevator car overload warning system of claim 1, wherein said control unit includes a remote annunciator for also indicating an elevator car overload condition to personnel at a remote location.

8. A method for warning of an elevator car overload condition, comprising;
sensing the weight of a load in said car;
detecting signals emitted from said sensor and thereby computing the weight of a load in said car; and
annunciating an overload condition to passengers within said car.

9. The method of claim 8, wherein said annunciating is delivered in the form of a prerecorded voice message.

10. The method of claim 9, wherein said prerecorded voice message informs the passengers in principal that the car will not operate until the overload condition is corrected by immediate exiting of passengers.

11. The method of claim 8, wherein said annunciating includes lighted signage.

12. The method of claim 8, including calculating the weight of load in the car per a given car floor area for thereby determining the existence of a passenger lying on a floor of the car.

13. The method of claim 8, including also annunciating the elevator car overload condition to personnel at a remote location.
